(19) United States
(12) Patent Application Publication
(10) Pub. No.: US 2008/0215992 A1
(43) Pub. Date: Sep. 4, 2008

(54) Method and Apparatus for Hosting Group Response Events

(75) Inventor: Amit Or, Mishmeret (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Inlive Interactive Ltd., Ra'anana (IL)

(21) Appl. No.: 11/886,239

(22) PCT Filed: Mar. 15, 2006
(86) PCT No.: PCT/IL06/00337

§ 371 Date: Mar. 12, 2008

(30) Foreign Application Priority Data
Mar. 16, 2005 (IL) 167485

(51) Int. Cl. G06F 3/048

(52) U.S. Cl. 715/753

(57) ABSTRACT

A system for allowing presentation of a Group Response Event (GRE) to a group of participants: the GRE comprising at least a first question and a range of possible answers to the at least a first question; the system comprising a hosting website accessible by at least one web-browser connected to a display, the web-browser and display being viewable by at least a first group of participants at a first location, such that members of said at least a first group of participants can individually respond to said at least a first question by inputting one of said range of possible answers via personal telecommunication devices.

### FIELD OF THE INVENTION

The present invention is directed to facilitating audience participation at conferences and the like, specifically, but not exclusively to preventing a system and method for creating and presenting interactive presentations via a web-enabled interface.

### BACKGROUND

Frontal lectures and presentations are a favored means of educating and informing. They are used at conferences and conventions, in company training sessions and the like.

It has long been appreciated that merely hearing the lecturer is not enough to maintain interest, and overhead projections, Microsoft PowerPoint presentations and the like, are widely used to provide visual interest, since they engage the eyes as well as the ears of the audience.

To maximize audience attention it is desired to convert the passive audience into active participants. Accepting occasional questions from the audience is a favored technique, but does little to maintain interest. Occasionally participants are invited to express an opinion or provide feedback by a show of hands. Children respond well to such tactics, but adult audiences find requests to raise their hands patronizing and may refuse to participate. Straw polls based on a show of hands are good for yes/no type questions and are useful where to show a consensus or lack of consensus. They are less useful for more sophisticated questions and where accurate counts are required. An audience may be expected to participate by voting once during a presentation. Requests for repeated voting are unlikely to be tolerated.

Several systems have been developed to allow responsive interaction with an audience. PCT Publication Number WO0113632A1, entitled Internet-Based Program Broadcast System” relates to an Internet-based program broadcast system for internet, that provides a decentralized network for the high-quality transmission or live or prerecorded interactive Internet-based programs such as shows, classes, and meetings to a virtually unlimited number of clients any place in the world. At least one bi-directional repeater/aggregator mediates between a server and one or more clients for receiving the program content from the server over the communication pipe and re-broadcasting the content to a plurality of clients, and aggregating data from the plurality of clients and sending a composite thereof to the server over the communication pipe. This system does not allow a number of viewers watching the presentation on the same screen to individually participate in the presentation.

U.S. Pat. No. 6,443,840, entitled “Game conducting system for players at remote location” and corresponding European Patent Number EP0686334B1 entitled “Generation Of Enlarged Participatory Broadcast Audience” describe a system and method for evaluating responses to broadcast programs, such as television programs, that include an instructional signal modulated onto a signal transmitted concurrently with the television program, simulcast, or time-multiplexed with a television. At each of a plurality of remote receiving stations, one or more members of a remote audience has the opportunity to respond to a situation presented in the television program by entering a response on a keyboard. The system includes response evaluation circuitry which may be located at a central facility or partially at the central facility and partially at each remote receiving station, or completely within a response unit at each remote receiving station, in the latter case the response unit having a memory responsive to the instructional signal for storing acceptable responses, a comparison circuit for comparing responses entered at the keyboard with those stored in the memory, circuitry for scoring responses in accordance with commands from the instructional signal, and a recording device for providing a permanent record of the audience score at the remote station. This system is typical of prior art systems in that a special keyboard is required.

U.S. Pat. No. 6,323,894 entitled, “Commercial product routing system with video vending capability” relates to an Interactive system for telephone and video communication with remote monitoring—provides remote monitoring, scheduling and processing capabilities, commercial product routing and video vending and selectively interfaces with members of groups as buyer groups and vendor groups. Conferences, conventions and video conferencing are discussed. However, the system does not seem to cater for several viewers at one location, allowing each viewer to actively participate.

WIPO Publication Number WO05050969 entitled “Mass Viewer Audience Circuit Based Real Time Participation In Interactive Applications Displayed Live On Display Screens”, incorporated herein by reference, is an earlier application of the present inventor. It is directed toward mass viewer audience circuit based real time participation in live TV shows, and other interactive applications displayed on electronic billboards, so-called vidiwalls, and the like. It utilizes a Mass Viewer Audience Response Detection gateway for establishing inbound half duplex line connections with callers' telephones on receiving circuit based telephone calls therefrom for determining callers' DTMF key depressions corresponding to their real time responses to an interactive application, and transmitting real time information regarding the callers' responses for providing real time feedback to the mass viewer audience watching the interactive application, and particularly the callers continuously holding their telephones like a hand held TV remote control and depressing on the DTMF keys on their telephones to input their responses to actively participate therein without interrupting their participation to listen to pre-recorded playback messages regarding DTMF key assignments. This publication describes a technology that allows a mass viewer audience, i.e. a GROUP, to participate in a TV show in real time. It does not relate to conferences and the like.

There are also commercial systems available that allow individuals to actively participate in conferences. However, in such systems, the participating individuals are provided with dedicated input devices, such as personal voting machines. The conference organizers have to rent the required equipment, which makes such systems expensive and requiring a significant logistical investment to implement.

There is a need for a cost-effective, reliable, simple system and method for producing and hosting interactive presentations to multiple participants. Preferably such a system should not require special hardware. The present invention addresses this need.

### SUMMARY OF THE INVENTION

In a first aspect, the present invention is directed to providing a system for allowing presentation of a Group Response Event (GRE) to a group of participants: the GRE comprising at least a first question and a range of possible answers to the at least a first question; the system comprising a hosting website accessible by at least one web-browser connected to a display, the web-browser and display being viewable by at least a first group of participants at a first location, such that members of said at least a first group of participants can individually respond to said at least a first question by inputting one of said range of possible answers via personal telecommunication devices.

Optionally the system is usable for an application selected from the list of judgment voting, surveys, multi-player games and sales activities, for example.

Typically, the hosting website is supported by an application server and comprises functional modules selected from the list of a Client Account Management Module for managing individual client accounts, a GRE Registration Module for allowing registration of individual group response events, a GRE Authoring Module for allowing authoring of GREs by a GRE Author, a GRE Activation Module for allowing activation of a GRE by an operator, a GRE Results Processing Module for processing answers to GRE questions and displaying same, and a Participant Data Logging Module for logging data input my participants via the personal telecommunication devices.

Optionally, the at least a first question has a range of possible answers and one answer is correct. Alternatively, the at least a first question has a range of possible answers and the system conducts a survey of responders.

In a further embodiment, participants may be grouped by their responses to a grouping question, such as income bracket, race, gender, age, education level, political affiliation, and the like. Subsequent questions may be tailored to specific groups or responses to subsequent questions may be analyzed on a group by group basis.

The personal telecommunication devices are typically selected from the list of mobile phones, telecommunication enabled personal organizers and wired telephone handsets.

In a second aspect, the present invention is directed to providing a web accessible application for facilitating hosting of Group Response Events, the web accessible application being supported on a network by an application server and being coupleable to display screens via network browsers and to personal telecommunication devices linked to the application server by a gateway via telephony communication channels, the web accessible application comprising functional modules selected from the list of a Client Account Management Module for managing individual client accounts, a GRE Registration Module for allowing registration of individual group response events, a GRE Authoring Module for allowing authoring of GREs by a GRE Author, a GRE Activation Module for allowing activation of a GRE by an operator, a GRE Results Processing Module for processing answers to GRE questions and displaying same, and a Participant Data Logging Module for logging data input by participants via the personal telecommunication devices.

Typically, the web accessible application is accessible via a website and the network is the Internet.

In a third aspect, the present invention is directed to providing a method of allowing a group of participants to participate in an interactive event comprising the steps of:
(i) providing a web accessible hosting service;
(ii) accessing the web accessible hosting service via the web;
(iii) displaying a question and a range of acceptable answers on a screen;
(iv) allowing a plurality of participants in said group of participants to respond to said question by inputting one of said range of said answers via personal telecommunication devices, such as mobile phones;
(v) repeating steps (iii) and (iv):

Optionally, the method further comprises the step of displaying the correct answer to the question.

Alternatively, the method further comprises the step of displaying responses to the question in an aggregated form.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic block diagram of the system of the invention;

FIG. 2 is a screen capture of an exemplary image downloadable from the website and displayable on the screen of the display means at event location;

FIG. 3 is a screen capture of an exemplary order form, allowing ordering of the a GRE event from a service provider, via the website thereof;

FIG. 4 is a screen capture of an exemplary GRE question form, allowing authoring of a GRE thereby, and

FIG. 5 is a flow chart of a method for hosting a Group Response Event.

### DESCRIPTION OF THE PREFERRED EMBODIMENTS

The present invention is directed toward providing, building and hosting Group Response Events, henceforth GREs, and providing a GRE hosting service, at conventions, company training sessions, and the like, in which group members or participants are required to simultaneously and independently indicate their responses to a list of questions/statements/comments, and the like, displayed on a display screen. Typically the group members' responses are aggregated and displayed in an attractive manner, perhaps using bar-charts, pie charts and similar graphical tools.

The hosting system may be used for judgment voting, for conducting surveys, for multi-player games and sales activities, for example.

It is a particular feature of preferred embodiments of the present invention, that participants may be grouped by their responses to a grouping question, directed a a parameter of interest such as income bracket, race, gender, age, education level, political affiliation, and the like. Subsequent questions may be tailored to specific groups or responses to subsequent questions may be analyzed on a group-by-group basis. Furthermore, groups can be proken into sub-groups, to obtain a picture of tastes, preferences, voting patterns, etc., for very specific targetted audiences, such as middle-aged, educated, high earning Caucasian females, for example.

Systems for hosting GREs are known. Conventional infrastructures for hosting GREs have many drawbacks however. Typically they require the deployment of a base station and a plurality of dedicated handheld keypads in data communication (wired or wireless) with the base station. The base station displays a presentation on a display screen for presenting a series of questions/statements/comments, and the like. Group members respond by depressing the appropriate pushbuttons on their keypads. The base station receives the group members' responses and displays the results on the display screen. Results can be filtered in accordance with one or more filtering questions, for example, Age, Pre sales managers/After sales managers, and the like. Moreover, conventional solutions require that a GRE presenter work in collaboration with service specialists to author the sequence of questions/statements/comments displayed and that a service specialist be on-site to activate and monitor the progress of a GRE event and ensure that the technical infrastructures are properly installed and in working order.

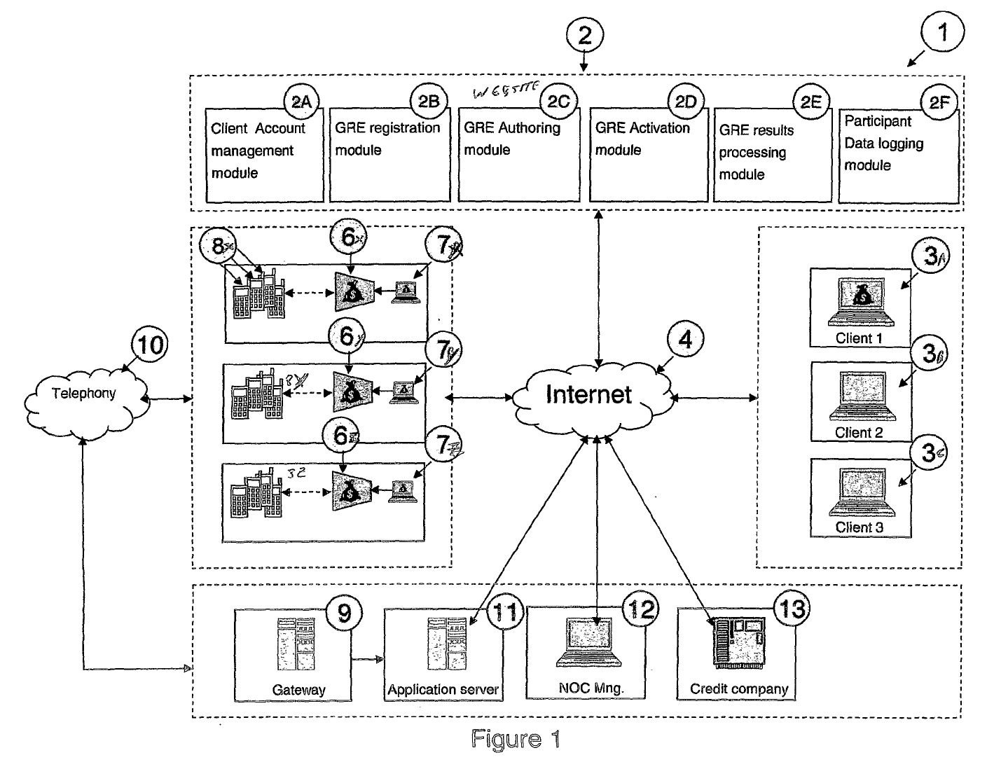

With reference now to FIG. 1, an infrastructure 1 for hosting GREs in accordance with one embodiment of the present invention is shown. The infrastructure 1 is a modular web-based system that includes a GRE hosting service website 2 and consists of the following modules: Client account management module 2A, GRE registration module 2B, GRE authoring module 2C, GRE activation module 2D, GRE results processing module 2E and Participant data logging module 2F. One or a plurality of Client computers 3A-C may connect to the GRE Hosting service website 2 via the Internet 4 for registration purposes, for scheduling, for authoring and for activating GREs.

During a seminar, conference etc., a GRE is presented on one or more display screens driven by client computer(s) 7X-Z connected to the GRE Hosting service website 2 via the Internet 4. The display screens will typically be wall screens onto which the client computer(s) 7X-Z project the images to be displayed, using appropriate projection means as standard in conference facilities. The display screens may, however, be LCD, CRT or plasma screens. The choice of screen depends on availability, number of participants at the location, and similar parameters.

The GRE may be run simultaneously at more than one location. By way of example, FIG. 1 shows a single GRE being simultaneously presented at three different locations.

The group members participating in a GRE participate via telephone handsets 8X (8Y, 8Z), typically by calling dedicated GRE telephone numbers via their personal mobile phones, or via landline telephones or mobile phones provided by conference organizers. Dedicated GRE telephone numbers enable the group members to connect to GRE gateways 9 via the telephony network 10. Group members indicate their responses by depressing designated pushbuttons on their handsets 8(X-Z). The GRE gateways 9 transmit information corresponding to the group members' responses to an Application Server 11 which is connected to the GRE Hosting Service website 2 via the Internet 4. The GRE results processing module 2E processes the group members' responses in real-time, and the system 1 will typically display and update the results or an aggregation thereof, on the display screen(s) 7(X-Z) in real time or at an appropriate moment in the program, allowing the group members to view them thereupon. The GRE hosting service may be managed and monitored by a Network Operations Center (NOC) 12. Payments for GREs may be settled by a credit company 13.

GRE telephone numbers will preferably be International Toll Free Service (ITFS) telephone numbers, so participants will not be charged for participating my their telephony service providers.

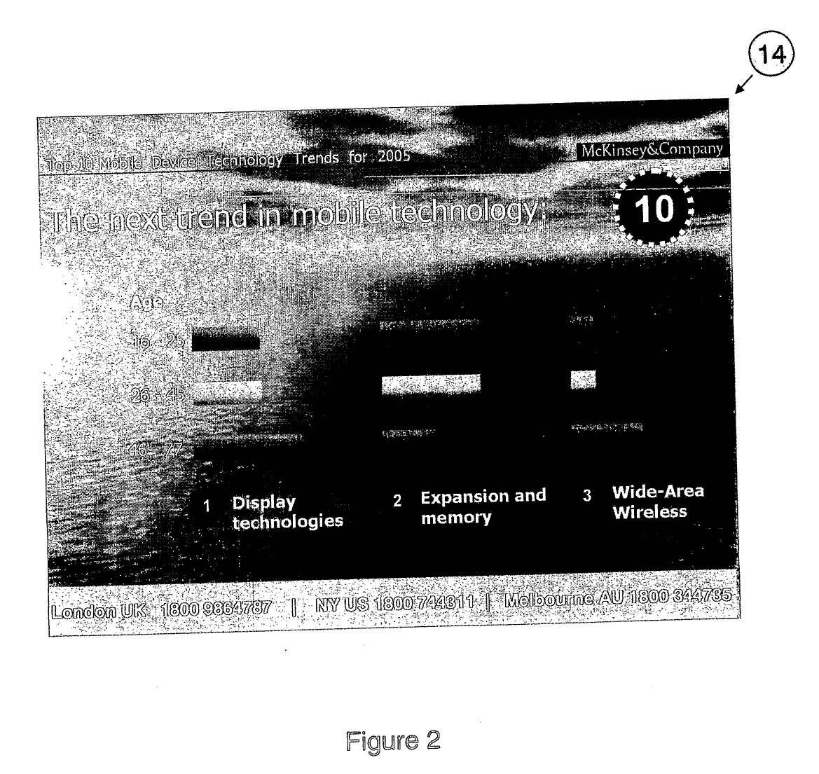

With reference to FIG. 2, by way of illustrative example, group members simultaneously participating in a geographically dispersed GRE taking place, for example, at three conference centers in London, UK, in New York, USA, and in Melbourne, Australia, will typically be instructed to call different GRE telephone numbers to reduce the overall cost of hosting a GRE. (This may be true of a geographically dispersed GRE taking place at two or more locations in the same country depending on call billing arrangements in that country) a screen capture of a display screen 14 at a McKinsey & Company annual convention entitled “Top 10 Mobile Device Technology Trends for 2005” is shown. The screen capture shows three ITFS callback telephone numbers: 1 800 986 4787 (London, UK), 1 800 744 311 (New York, US) and 1 800 344 735 (Melbourne, Australia) and the results of three age groups 16-25, 26-45 and 46-77 ranking three technologies: (i) Display technologies. (ii) Expansion and memory and (iii) Wide Area Wireless.

It will be appreciated that by virtue of hosting the GRE on an Internet site 2, the same screen image, such as the illustrative screen capture 14 described above, can be viewed at the same time on a plurality of displays such as computer screens or projected displays at a plurality of locations, that may be in different countries or even on different continents. Consequently, it will be appreciated that the present invention affords a convenient user friendly environment for hosting GREs at either a single location or a plurality of geographically dispersed locations which may be in different cities or even different countries or continents. Potential GRE users include corporate clients, convention centers, service providers, and independent users.

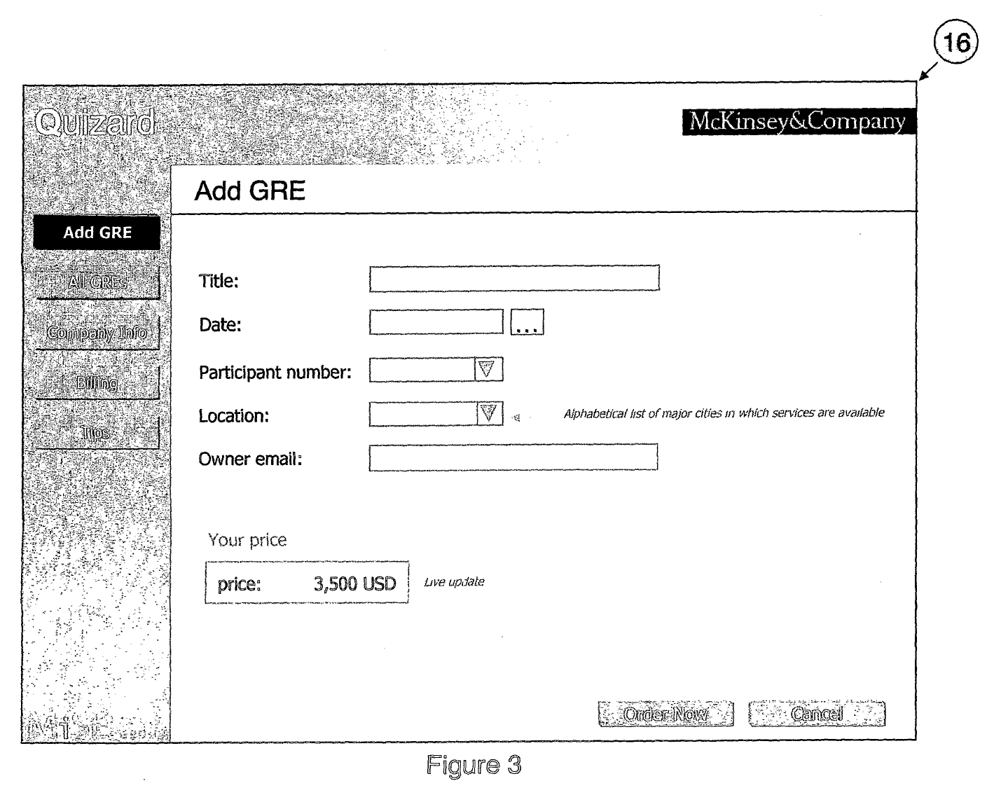

With reference to FIG. 3, in a preferred embodiment, a set of GRE authoring tools 16 are provided to enable presenters with no special software installation and no specialized expertise to independently author and configure events for running on the Internet. Such tools may be configured to utilize a Web interface, or as a wizard.

The component modules of a preferred embodiment of the system 1 as hosted on the GRE Hosting Service Website 2 are now detailed.

With reference to FIG. 3, one example of a GRE registration GUI screen 16 for a GRE Registration Module (2B) is shown. GRE registration GUI screen 16 allows for entering the following details:

1. Title

2. Date and time

3. Participant Number

4. Location(s)

5. Owner email

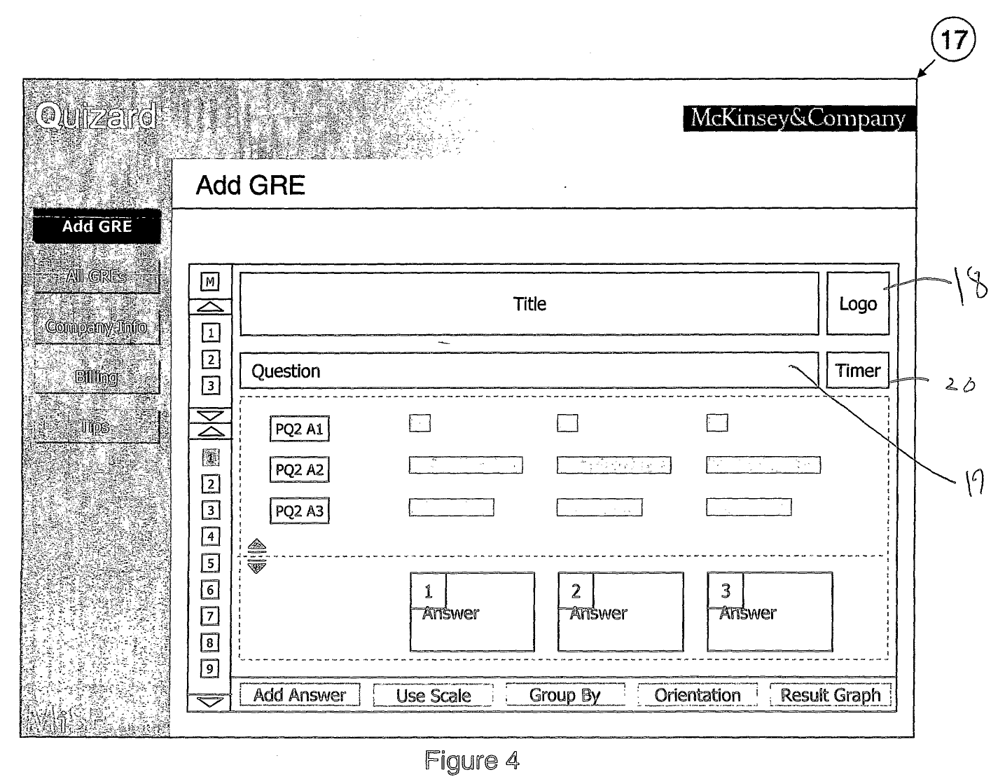

Referring back to FIG. 1, one embodiment of the GRE Authoring Module 2C is configured to enable GREs to be designed and authored in a similar manner to that used to author Microsoft Powerpoint presentations. GRE organizers can author GREs remotely, such as from their own computers, and upload them to the GRE Hosting service website 2, via the web 4c. With reference to FIG. 4, which shows an example of a GRE authoring module GUI screen 17 for designing a GRE in a preferred embodiment GRE authors may design and customize templates to include company logos, to choose background colors, and the like. GRE authors also configure default activation parameters for running a GRE. The default activation parameters may also be stored as a preset activation scheme. The GRE authoring module 2C preferably enables the running of simulations of a GRE using randomly generated responses to questions 19/comments/statements, and the like.

Typically, GRE designs include some of the following Design Parameters:
Background image
Header text (title . . . )
Header font, weight and color.
Company Logo (graphic, display size: small/medium/large, position: top/middle/bottom+left/center/right).
Font (used for both questions and answers)
Question background color
Question font color
Answer font color
Correct Answer background color
Correct Answer graphic indicator (select from list)

The design of a GRE may usefully be performed using a template, and preferred embodiments of the GRE Authoring Module 2C include both a range of such templates and/or the facility for designing and storing proprietary templates.

GRE Content authoring includes:
Adding/Deleting Profiling Questions used for grouping results in content questions.
Adding/Deleting content questions
Changing question order

For each question answers may be entered by: Specifically authoring answers (up to n answers), or by selecting one of a preset scale of responses to apply, such as the scale of from one to five, where one indicates LIKE, and five indicates DISLIKE. Optionally, the results may be grouped by one of the profile questions.

Usefully the system allows an indication if a particular question has a correct answer, and, if so, to indicate one correct answer.

Preferably the authoring module 2C allows the author to choose both the question and the result layouts, and where the GRE includes open ended questions, for example, an appropriate format for displaying statistical results of the results obtained, such as an appropriate graph type may be chosen.

The appropriate activation parameters for running the GRe are set by the author. Various standard activation default configurations are provided. For example, each question may be displayed in turn in response to an operator click, e.g. the session coordinator at the central conference location triggering the response. The subsequent question, may however, be set by author to be displayed automatically n seconds after the previous question is hidden.

The author may also control the ways that the questions and answers are displayed on the screens to the participants. For example, preferred embodiments will support the various display options supported by presentation programs such as MS Powerpoint. By way of non-limiting examples, the questions 19 may fly onto the screen from the left, the right, the top or the bottom, or may fade in. Similarly, the answers may fly onto the screen from the left, the right, the top or the bottom, or may fade in. The answers may appears one at a time, one by one with an authoer defined interval of n seconds between each answer appearing, and an interval of m seconds between the question being displayed, and the answers being shown. The answers may, be set to appear all together after the m second interval, or their appearance may depend on an operator click.

Where questions are of a survey nature and the audience is polled, the voting may be set to start manually by an Operator click, or n seconds after the first answer is received or displayed, the voting may be stopped and all answers displayed, using an appropriate graphical display format selected by the author.

Similarly, questions may be hidden from view in response to an operator click or automatically, n seconds/minutes after the voting ends and/or after the correct answer/audience response is displayed.

As shown in FIG. 1, the system 1 includes a GRE Activation Module 2D. The GRE Activation Module 2D can activate a GRE at a particular location or a GRE simultaneously at two or more geographically dispersed locations. The GRE Activation Module 2D can activate a GRE at a presentation site or remotely by suitable passwords and the like. The GRE presenter can control the progress of a GRE by pausing a presentation, moving forward and backwards between questions, restarting the presentation, etc.

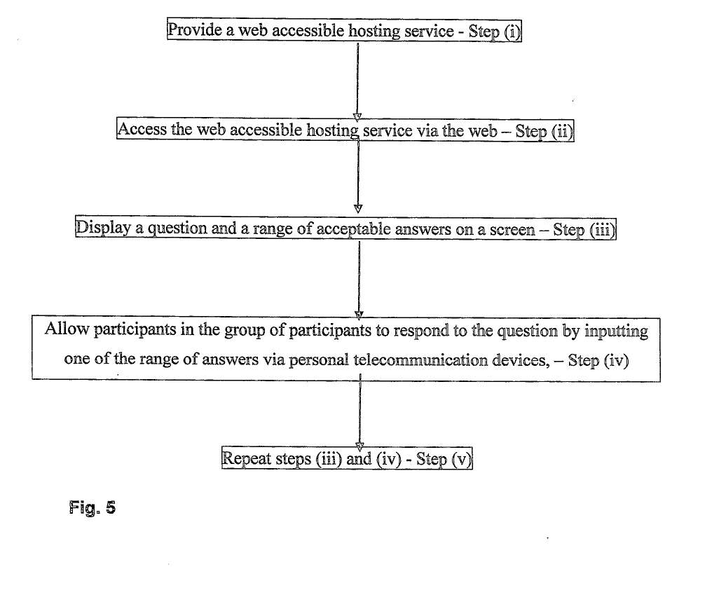

With reference to FIG. 5, a method of allowing a group of participants to participate in an interactive event is shown. The method comprises the steps of:
(i) providing a web accessible hosting service;
(ii) accessing the web accessible hosting service via the web;
(iii) displaying a question and a range of acceptable answers on a screen;
(iv) allowing a plurality of participants in said group of participants to respond to said question by inputting one of said range of said answers via personal telecommunication devices, such as mobile phones;
(v) repeating steps (iii) and (iv).

Where a quiz type question is displayed, the method includes the step of displaying the correct answer to the question. Where, however, the question is a survey type question, the method includes the step of displaying responses to the question in an aggregated form, such as a bar chart, pie chart, percentage and the like.

It is a particular feature of the present invention, that the interactive program or GRE is hosted by a website 2 on the Internet 4 and interaction is by viewers' mobile phones 8. This has a number of advantages:
(a) The technology allows an audience of virtually any size, at a single or multiple locations, to view a presentation and to interact via their mobile phones 8.
(b) The conference hosts are simply required to provide an internet browser, such as a laptop computer or PC 7, connected to the Internet 4, via a phone line, blue tooth connection or the like, and a projector system coupled thereto. The required hardware is standard at conference centers, universities and the like, and is relatively cheap to buy, rent or borrow.
(c) The presentation can be compiled easily, by the lecturer for example, using a user friendly wizard (See FIGS. 3 and 4, for example). Compilation is via the web, and may be performed from anywhere with Internet access, at any time prior to running the GRE.
(d) In preferred embodiments, Compilation is performed on line, and does not require the downloading of any software to the compiler's web access system.
(e) The presentation, once compiled, can be accessed, and adapted if necessary, by the lecturer from his office in advance, in the eleventh hour from his hotel room at the conference venue, or at the conference hall just before the presentation.
(f) The presentation may be accessed and adapted in the eleventh hour by a third party situated anywhere in the world.
(g) Past presentation may be easily accessed and re-displayed anywhere in the world having an internet connection.
(h) Past presentation may be easily accessed and reedited for use in other conferences.
(i) Past presentation may be re-displayed anywhere in the world having an internet connection.

Since the service is activated via the web, providing the service is relatively inexpensive, when compared to prior art systems.

A single service provider can allow a number of customers to host GREs at their convenience, using standard equipment, anywhere in the world having mobile phones and internet access. Pricing for such services will typically be based on the intended size of a GRE in terms of group members, intended duration, and location(s). Different service packages may be designed for different types of potential users. Such service packages may range from one-time pre-paid GREs through to large enterprise contracts suitable for multi-national corporations.

It will be appreciated that that the embodiments shown above are described by way of example only, and the scope of the invention is to be understood from the appended claims.

In the following claims, the term “comprise”, and variations thereof, such as comprising, comprised and the like, imply that the specified components or steps are included, but not necessarily to the exclusion of other components or steps.

1. A system for allowing presentation of a Group Response Event (GRE) to a group of participants: the GRE comprising at least a first question and a range of possible answers to the at least a first question; the system comprising a hosting website accessible by at least one web-browser connected to a display, the web-browser and display being viewable by at least a first group of participants at a first location, such that members of said at least a first group of participants can individually respond to said at least a first question by inputting one of said range of possible answers via personal telecommunication devices.

2. Use of the system of claim 1, for an application selected from the list of judgment voting, surveys, multi-player games and sales activities.

3. The system of claim 1, wherein said hosting website is supported by an application server and comprises functional modules selected from the list of a Client Account Management Module for managing individual client accounts, a GRE Registration Module for allowing registration of individual group response events, a GRE Authoring Module for allowing authoring of GREs by a GRE Author, a GRE Activation Module for allowing activation of a GRE by an operator, a GRE Results Processing Module for processing answers to GRE questions and displaying same, and a Participant Data Logging Module for logging data input by participants via the personal telecommunication devices.

4. The system of claim 1 wherein said at least a first question has a range of possible answers and one answer is correct.

5. The system of claim 1 wherein said at least a first question has a range of possible answers and the system conducts a survey of responders. The system of claim 1 wherein a preliminary question is a grouping question and participants are grouped by their responses to the grouping question, and subsequent questions are tailored to specific groups.

6. The system of claim 1 wherein a preliminary question is a grouping question and participants are grouped by their responses to the grouping question, and subsequent responses to subsequent questions are analyzed on a group by group basis.

7. The system of claim 1 wherein said personal telecommunication devices are selected from the list of mobile phones, telecommunication enabled personal organizers and wired telephone handsets.

8. A web accessible application for facilitating hosting of Group Response Events, the web accessible application being supported on a network by an application server and being coupleable to display screens via network browsers and to personal telecommunication devices linked to the application server by a gateway via telephony communication channels, the web accessible application comprising functional modules selected from the list of a Client Account Management Module for managing individual client accounts, a GRE Registration Module for allowing registration of individual group response events, a GRE Authoring Module for allowing authoring of GREs by a GRE Author, a GRE Activation Module for allowing activation of a GRE by an operator, a GRE Results Processing Module for processing answers to GRE questions and displaying same, and a Participant Data Logging Module for logging data input my participants via the personal telecommunication devices.

9. The web accessible application of claim 8 further being accessible via a website and the network being an Internet.

10. A method of allowing a group of participants to participate in an interactive event comprising the steps of:
(i) providing a web accessible hosting service; (ii) accessing the web accessible hosting service via the web;
(iii) displaying a question and a range of acceptable answers on a screen;
(iv) allowing a plurality of participants in said group of participants to respond to said question by inputting one of said range of said answers via personal telecommunication devices, such as mobile phones; (v) repeating steps (iii) and (iv).

11. The method of claim 10 further comprising the step of displaying correct answer to said question.

12. The method of claim 10 further comprising the step of displaying responses to said question in an aggregated form.
